(19) United States
(12) Patent Application Publication
(10) Pub. No.: US 2013/0257258 A1
(43) Pub. Date: Oct. 3, 2013

(54) LED LAMP

(71) Applicants: Chih-Ming YU, Zhubei City (TW); Jui-Ming HUA, Kaohsiung City (TW); Jen-Chien WANG, Zhubei City (TW)

(72) Inventors: Chih-Ming YU, Zhubei City (TW); Jui-Ming HUA, Kaohsiung City (TW); Jen-Chien WANG, Zhubei City (TW)

(21) Appl. No.: 13/780,250

(22) Filed: Feb. 28, 2013

(30) Foreign Application Priority Data
Mar. 30, 2012 (TW) 101111263

(51) Int. Cl. F21V 29/00

(52) U.S. Cl. CPC F21V 29/004
USPC 313/46

(57) ABSTRACT

An LED lamp according to the present disclosure includes an electrical base, at least one LED chip positioned on the electrical base, a cover covering the LED chip, and a heat dissipation layer formed on the cover. The heat dissipation layer has a thermal conductivity greater than that of the cover.

### CROSS REFERENCE TO RELATED APPLICATION

This application claims the priority benefit of Taiwan Patent Application Serial Number 101111263 filed Mar. 30, 2012, the full disclosure of which is incorporated herein by reference.

### BACKGROUND OF THE INVENTION

1. Technical Field

The present invention relates to a lamp, and more particularly, to an LED lamp.

2. Description of the Related Art

LEDs have the advantage of low power consumption and high power efficiency. Therefore, LEDs have been used as illumination light sources.

Referring to FIG. 1, a conventional LED lamp 100 includes an electrical base 110 and at least one LED chip 120 positioned on a surface 112 of the electrical base 110. A cover 130 is used to cover the LED chip 120.

However, the above LED lamp 100 uses only the electrical base 110 made of metal to dissipate heat during operation. Therefore, the heat dissipation is not good. This will cause the LED chip 120 to have a reduced light efficiency.

In view of the above, a finned heat sink is commonly mounted to the electrical base to enhance the heat dissipation. For the purpose of heat dissipation, the finned heat sink is a good design. However, the introduction of a finned heat sink will expand the LED lamp. Furthermore, this will also increase considerably the production cost.

Accordingly, there exists a need to provide a solution to solve the aforesaid problems.

### SUMMARY

The present disclosure provides an LED lamp that may dissipate heat into the atmosphere during operation.

In one embodiment, the LED lamp includes an electrical base, at least one LED chip positioned on the electrical base, a cover covering the LED chip, and a heat dissipation layer formed on the cover. The heat dissipation layer has a thermal conductivity greater than that of the cover.

In another embodiment, the LED lamp includes an electrical base, at least one LED chip positioned on the electrical base, and a cover covering the LED chip. The cover is made from a main material mixed with a heat dissipation material, wherein the main material has a weight ratio greater than that of the heat dissipation material in the cover, and the heat dissipation material has a thermal conductivity greater than that of the main material.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is a schematic view of a conventional LED lamp.

FIG. 2a is a schematic view of the LED lamp according to the first embodiment of the present disclosure.

FIG. 2b is a locally enlarged view of FIG. 2a.

FIG. 3a is a schematic view of the LED lamp according to the second embodiment of the present disclosure.

FIG. 3b is a locally enlarged view of FIG. 3a.

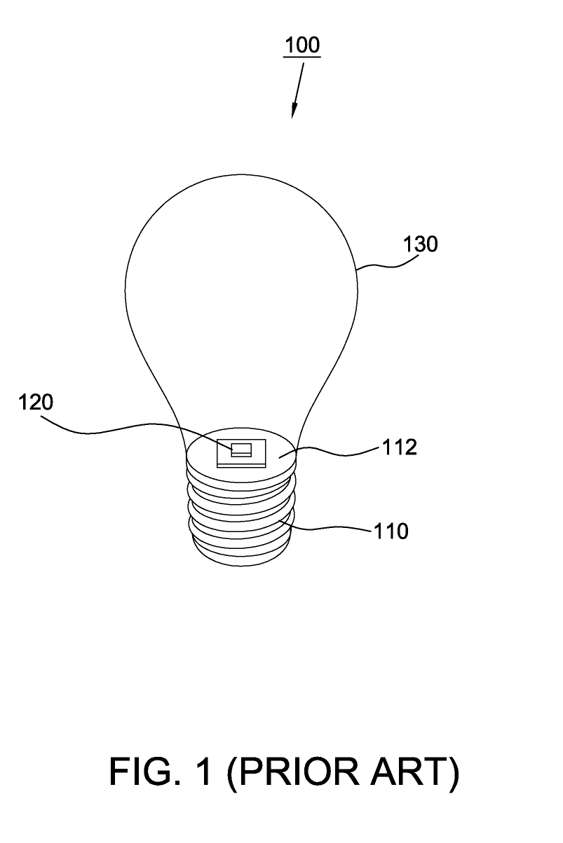

### DETAILED DESCRIPTION OF THE PREFERRED EMBODIMENT

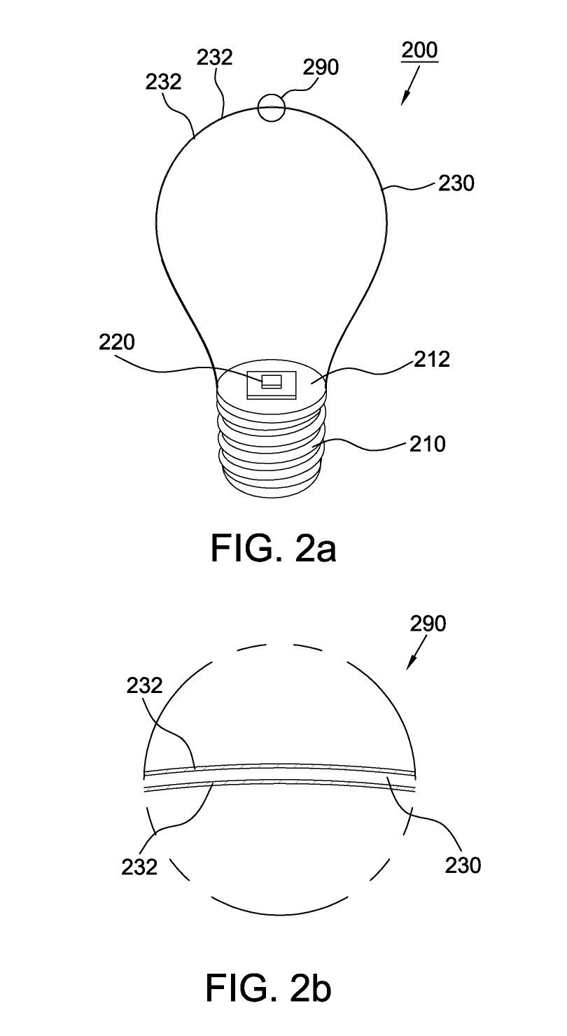

Referring to FIGS. 2a and 2b, the light emitting diode (LED) lamp 200 according to the first embodiment of the present disclosure includes at least one LED chip 220 positioned on a surface 212 of an electrical base 210. A cover 230 is used to cover the LED chip 220. In one embodiment, the cover 230 may be transparent or opaque. The cover 230 may be made from glass, plastics or a material with high light-transmittance.

In addition, a heat dissipation layer 232 is formed on the cover 230. The heat dissipation layer 232 may be coated on an inner surface and/or outer surface of the cover 230 by a process of vacuum evaporation, wet coating, immersion plating or spray coating. The heat dissipation layer 232 has a thermal conductivity greater than that of the cover 230, for example, greater than 1.1 W/(mK) for better heat dissipation.

According to the present disclosure, wherein the heat dissipation layer 232 is made from a material with larger thermal conductivity. For example, the heat dissipation layer 232 may be made from metal, graphite, artificial diamond, carbon nanotube or ceramics, e.g. aluminum oxide, aluminum nitride or boron nitride.

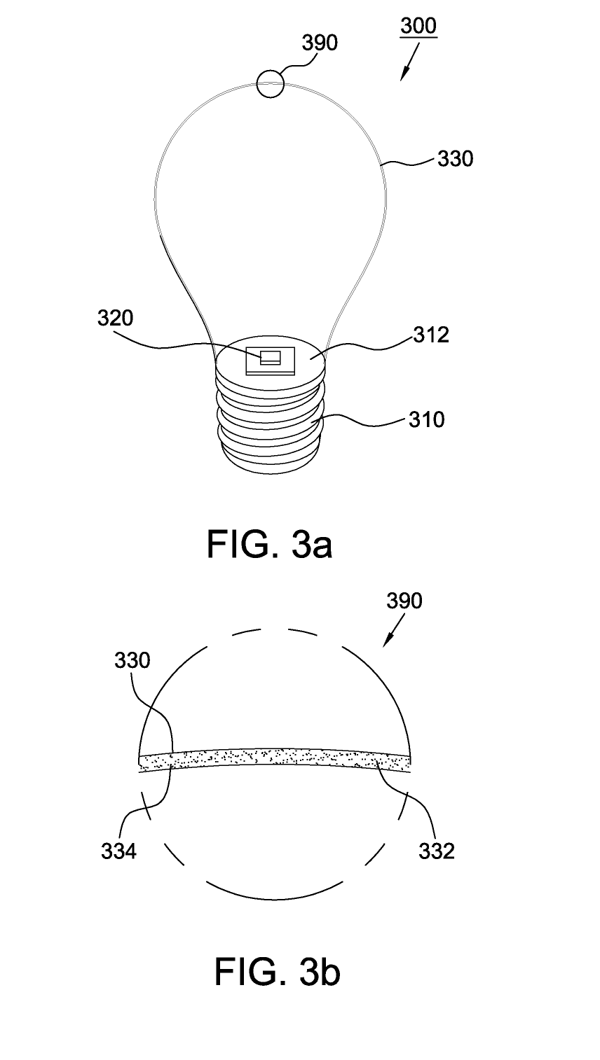

Referring to FIGS. 3a and 3b, the light emitting diode (LED) lamp 300 according to the second embodiment of the present disclosure includes at least one LED chip 320 positioned on a surface 312 of an electrical base 310. A cover 330 is used to cover the LED chip 320. In one embodiment, the cover 330 is made from a main material 332 mixed with a heat dissipation material 334. The main material 332 has a weight ratio greater than that of the heat dissipation material 334 in the cover 330. In addition, the heat dissipation material 334 has a thermal conductivity greater than that of the main material 332, for example, greater than 1.1 W/(mK) for better heat dissipation.

According to the present disclosure, wherein the main material 332 may be a transparent or opaque material. The main material 332 may be glass, plastics or a material with high light-transmittance. The heat dissipation material 334 mixed in the main material 332 may be a metal powder, graphite, artificial diamond powder, carbon nanotube powder or ceramic powder, e.g. aluminum oxide, aluminum nitride or boron nitride.

According to the present disclosure, the heat generated by the LED chips may be dissipated into the atmosphere by the heat dissipation layer coated on the cover or by the heat dissipation material mixed in the cover. This way the temperature of the LED lamps may be reduced. The light efficiency and lifetime of the LED chips may be enhanced accordingly.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An LED lamp, comprising:
an electrical base;
at least one LED chip positioned on the electrical base;
a cover covering the LED chip; and
a heat dissipation layer formed on the cover, wherein the heat dissipation layer has a thermal conductivity greater than that of the cover.

2. The LED lamp as claimed in claim 1, wherein the heat dissipation layer is formed on an inner surface of the cover.

3. The LED lamp as claimed in claim 1, wherein the heat dissipation layer is formed on an outer surface of the cover.

4. The LED lamp as claimed in claim 1, wherein the heat dissipation layer has a thermal conductivity greater than 1.1 W/(mK).

5. The LED lamp as claimed in claim 1, wherein the heat dissipation layer is made from a material selected from the group consisting of metal, graphite, artificial diamond, carbon nanotube and ceramics

6. The LED lamp as claimed in claim 1, wherein the heat dissipation layer is made from a material selected from the group consisting of aluminum oxide, aluminum nitride and boron nitride.

7. An LED lamp, comprising:
an electrical base;
at least one LED chip positioned on the electrical base; and
a cover covering the LED chip, wherein the cover is made from a main material mixed with a heat dissipation material, the main material has a weight ratio greater than that of the heat dissipation material in the cover, and the heat dissipation material has a thermal conductivity greater than that of the main material.

8. The LED lamp as claimed in claim 7, wherein the thermal conductivity of the heat dissipation material is greater than 1.1 W/(mK).

9. The LED lamp as claimed in claim 7, wherein the heat dissipation material is made from a material selected from the group consisting of metal, graphite, artificial diamond, carbon nanotube and ceramics

10. The LED lamp as claimed in claim 7, wherein the heat dissipation material is made from a material selected from the group consisting of aluminum oxide, aluminum nitride and boron nitride.
